(19) United States
(12) Patent Application Publication
(10) Pub. No.: US 2011/0307389 A1
(43) Pub. Date: Dec. 15, 2011

(54) Method and System for Distributed Point of Sale Transactions

(75) Inventors: Steve Francia, Wilton, CT (US); Justin Michael Hileman, New York, NY (US); Michael Andrew Stanberry, New York, NY (US)

(73) Assignee: Opensky Project, Inc., New York, NY (US)

(21) Appl. No.: 12/842,759

(22) Filed: Jul. 23, 2010

Related U.S. Application Data
(63) Continuation-in-part of application No. 12/826,521, filed on Jun. 29, 2010, now abandoned.
Application No. 12/826,521 is a continuation-in-part of application No. 12/826,532, filed on Jun. 29, 2010, now abandoned.
(60) Provisional application No. 61/355,044, filed on Jun. 15, 2010.

(51) Int. Cl. G06Q 20/00; G06Q 40/00; G06Q 30/00

(52) U.S. Cl. 705/67; 705/65; 705/26.8; 705/44

(57) ABSTRACT

A method and system for a fully distributed on-line selling environment is presented. Any webpage can contain a program module that for each customer that view any webpage with the module embedded in it, automatically associates that customer with their corresponding shopping cart stored at a central server. The module can initiate a sale transaction for a product presented on the webpage and cause the central server to complete the purchase and fulfillment. The website hosting the webpages with the module do not operate any back end transaction processing or order fulfillment. Instead the central server can retrieve a pending sales data associated with the customer and then initiate a payment process for the pending sale items as well as generate revenue share credits for the webpages associated with the sales.

### PRIORITY CLAIM

This application claims priority to provisional application U.S. Patent Application No. 61/355,044 filed on Jun. 15, 2010 and is a continuation in part of U.S. patent application Ser. No. 12/826,521 filed on Jun. 29, 2010 and U.S. patent application Ser. No. 12/826,532 filed on Jun. 29, 2010 all of which are incorporated herein by reference in their entirety.

### SUMMARY OF THE INVENTION

When considering the typical on-line retail outlet, the appearance is of a shop-front. A centralized website hosts the actual presentation of inventory and executes the point of sale transaction. Some centralized retail outlets that utilize the Internet permit other websites to link to their websites in order to attract referral traffic. With this example of prior art one webpage contains a “buy now” button that appears to the customer as a button, but actually causes the browser to switch addresses to the centralized retailer's website, specifically a location on that website where hopefully the intended product is available. Other prior art includes having the “buy now” button cause a FLASH program to launch that essentially acts like a stand alone point of purchase that appears as a new window to overlay the original website. The fundamental problem with this prior art is that the proprietor of the first website loses control over the customer. For example, an on-line pet shop that presents a dog-collar offered by a large retailer actually loses the customer to the large retailer's website. Another related problem is that the point of sale appearance cannot interact with the actual content of the originating website. Finally, this prior art approach makes it difficult for a website designer to carefully and easily integrate merchandise sales into the website without taking on the full task of operating an e-commerce website. This last problem has made it difficult to impossible for websites primarily devoted to providing information to integrate a sales transaction directly into the content that they present.

Therefore, there is a need for a distributed point of sale architecture that permits any website that attracts interest from customers to generate sales transactions without operating a full e-commerce capability and to conduct sale transactions in a manner that appears seamless to the customer of the website. In addition, there is a need for this architecture to permit websites that do not want to build and sustain their own sales infrastructure to take advantage of a distributed architecture that provides a simple way to integrate product sales into a website's content. The distributed sales architecture provides back-end transaction processing, inventory management and order fulfillment in a manner invisible to the customer. In this architecture, the presentation of inventory and the point of sale transaction are distributed across many unrelated websites. Each website, or even web-pages in a website can have different inventory and conduct its own sales. The invention supports the management of the inventory across the range of web-pages and handles the back-end transaction processing. With this architecture, it is also possible to design the system so that a given customer who shops at a range of different and distinct websites may nonetheless have their pending selection of items for purchase handled using a shopping cart that is associated with the customer, not the websites where the transactions were initiated. The invention provides the appearance of a shopping cart that is unique to the user, rather than the webpage or website where the product item was selected. In other words, each cart instance is unique to the user, not the vendor. In this way, on-line sales to a customer become distributed across many websites and webpages while the back-end system is able to assist in transaction fulfillment.

### BRIEF DESCRIPTION OF THE DRAWINGS

FIG. 1: Screenshot of shopping cart page rendered by code module.

FIG. 2: Screenshot of website checkout registration page.

FIG. 3: Screenshot of customer registration page.

FIG. 4: Screenshot of customer shipping data input page.

FIG. 5: Screenshot of payment page with credit card data input.

FIG. 6: Diagrammatic presentation of system architecture of the invention.

FIG. 7: Flowchart for widget.

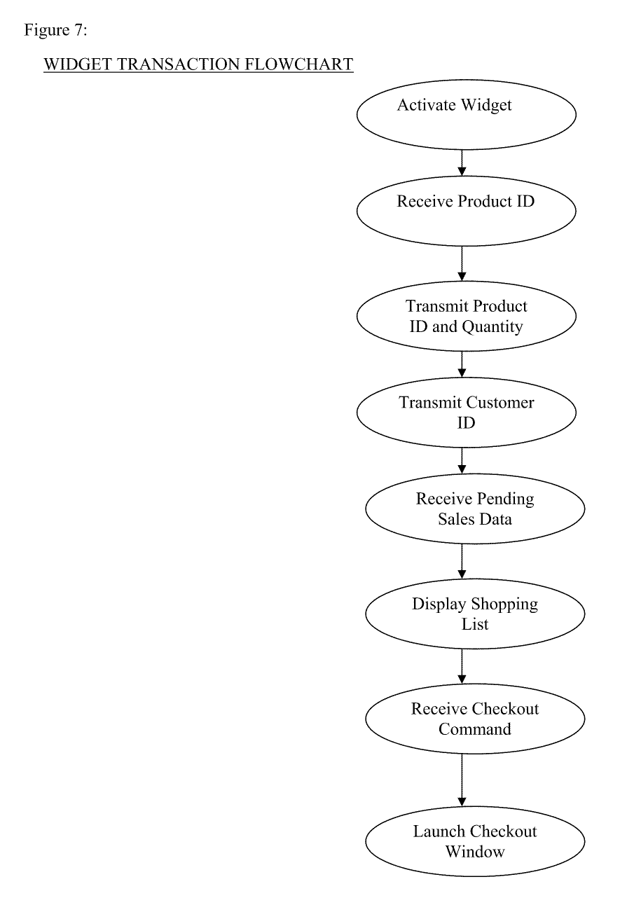

FIG. 8: Flowchart for central server.

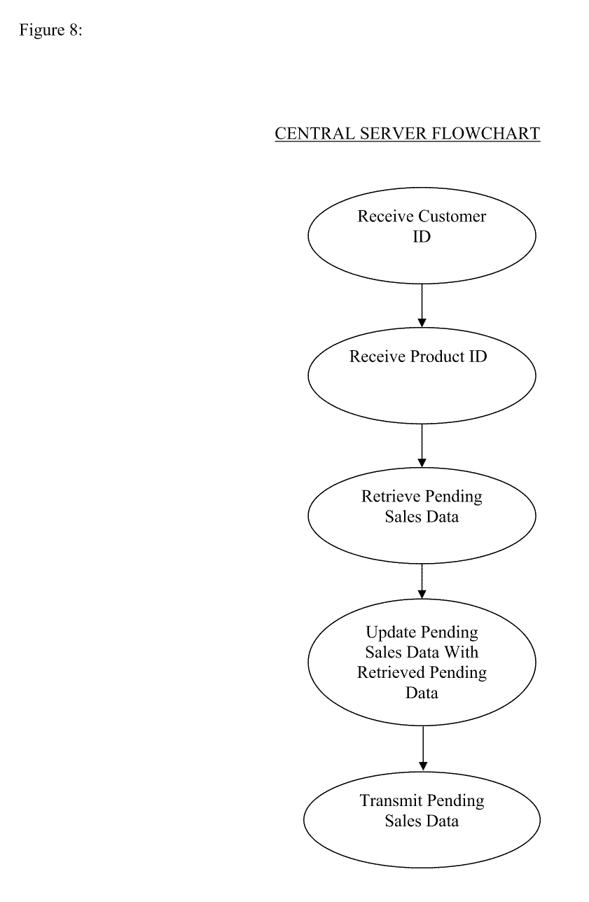

FIG. 9: Flowchart for checkout module.

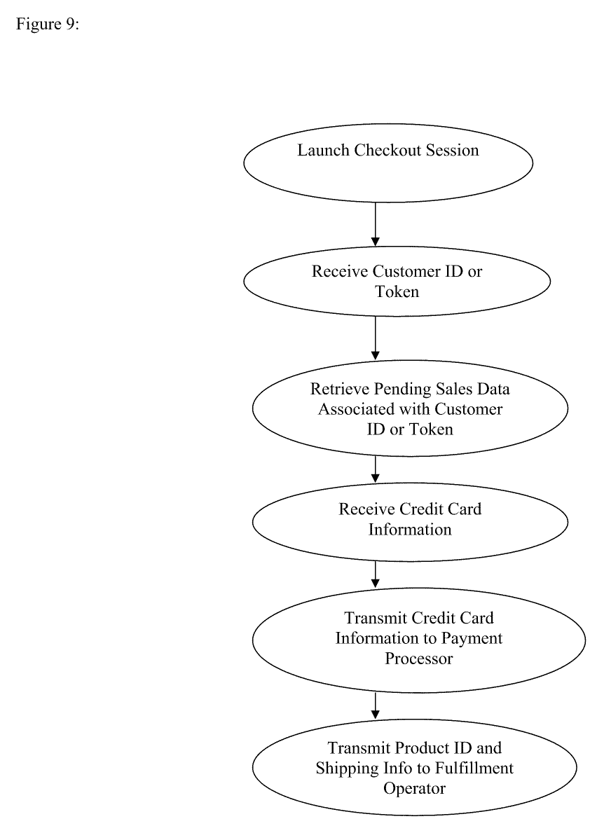

FIG. 10: Diagrammatic presentation of checkout module connections.

### DETAILED DESCRIPTION OF THE PREFERRED EMBODIMENTS

The architecture of the invention is comprised of many webpages hosted by different websites and entities at different URL's, under different, unrelated domains, where one or more individuals present text, pictures, video, music, sounds and any other media of interest to the public. Some of these webpages contain content that is relevant to a particular field of interest. For example, a webpage may be a blog containing text content relevant to owning pets. The individuals who create the content are empowered by using the invention to also sell products from their webpages. These individuals who can influence prospective purchasers are identified in this application as “Sellers.” The Sellers can pick and choose from inventory that is offered by the system that comprises the invention, including from entities that wish to sell their products through this system, referred to as “Suppliers”. The Seller can input through a web-browser, API or other interface identifying information or other authentication methods, for example, a login identifier and password. The Seller can then select from a catalog of inventory items made available by Suppliers that they would like to sell from their website. The selection process can be automated. For example, a Seller may start writing a blog on a topic. The central server may receive this text and then using key-word searching or other heuristics, determine one or more candidate items in inventory that are relevant to the text. These items can be presented to the Seller in a window and the Seller can click on one or more of these items and drag a link into the page they are composing. Once these selections are made, the Seller's webpage is automatically updated to present these items as available for sale from Seller's webpage hosted on Seller's website or wherever Seller has their webpage hosted. In the example described here, the Seller with an interest in pets may select a particular dog collar for sale. When the Seller has made a selection, the code that comprises the Seller's webpage, which in one embodiment is HTML, is updated to include the necessary information, for example, a unique product identifier, image data, inventory information and pricing. The product identifier is associated with a “buy” button or a text link or other object that is selectable by the customer that is appropriately inserted in the webpage, typically proximate to the image and description of the product item. A website may have multiple items residing on multiple webpages. For example, an on-line newspaper may have a cooking section that has food related items, for example pans, for sale on that webpage, while the travel section may have travel related items, for example, suitcases.

### Transaction Widget:

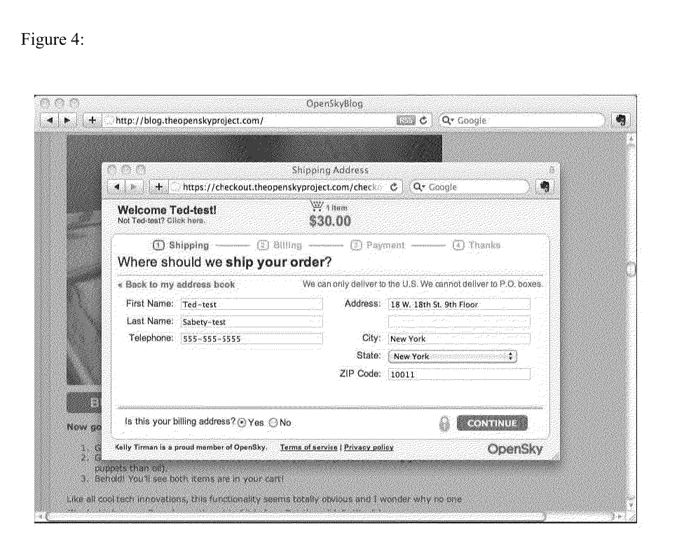

A particular product selected by Seller, in this case, a dog collar, may also be selected by other websites that for one reason or another (including interest in pets) decide to sell the same collar. The invention manages the transaction needs of all of these otherwise unrelated websites. As the central system determines that inventory has been sold, the availability is updated on all the webpages that have the same product identifier. That is accomplished by a program code module that is integrated into the code of the webpages, referred to in this application but without the intent of limitation other than as explained herein, a widget. A widget may be a set of JavaScript instructions embedded in an HTML document, a link in the HTML document that launches a script or any other program instructions which may be interpreted by the browser or passed by the browser to another process to be interpreted or directly executed by the customer's computer. Referring to FIG. 4, the visitor to the Seller's webpage downloads the webpage with the widget embedded in it. (1) The widget (3) is activated by the browser (2) on the user's computer that displays the web page. In one preferred embodiment, a one or more central server or servers provide a set of API's that can be accessed across the Internet by the widget. The widget accesses the central server system through the API's. (4) The Sellers are associated with sales initiated on their webpage or website by means of the widget. Each widget has a unique identifier embedded in it, which can be a number or alphanumeric string that is unique to the Seller whose webpage or website the widget occupies. When a Seller requests a widget for installation on their webpage, a unique widget is delivered. When that widget is activated to sell an item to a customer visiting Seller's webpage, the widget transmits the Seller's identifier along with the transaction information to the central servers. This way the sale can be attributed to the particular Seller where the widget originated.

The widget becomes active when the webpage it is contained in is displayed on a customer's browser. The customer's browser calls for the webpage and when it renders the webpage, the browser launches the widget. The widget operating on customer's computer will periodically read the product identifiers that are embedded into Seller's webpage downloaded to customer's computer where the widget resides and it transmits that data to the central server. The server then responds with updated inventory, pricing or other information that may change over time. The widget can then change the webpage data object displayed on the user's computer so that such information is updated in the display.

The widget can update the Seller's webpage, when it is first rendered on the customer's computer or whenever an event occurs on the page. The widget can be triggered to operate upon the first display of the webpage, or upon certain active events that occur, for example, cursor clicks, redisplays, selection of buttons or other actions taken by the customer when interacting with the webpage. A widget can be programmed to periodically update, based on time or any other triggering event. The most important update occurs when the customer presses “buy now” and “checkout” because that is when the transaction is going to be completed.

The updating of the webpage occurs after it has been downloaded to the customer's computer. The widget is able to call on the server to provide inventory and pricing information by means of a unique identifier associated with the product item displayed on Seller's webpage. Each item gets a “Sellable Item ID” number. The central server can use different product ID's or their Sellable ID's. In one embodiment, this can be an SKU number or other unique product identifier. SKU numbers are what the Supplier uses for their own inventory. In one embodiment, each product available for Sellers is identified by a UUID, a 16 character ID that is part of an industry standard. In another embodiment, each sellable item on a Seller's webpage has a unique string that appears as a portion of the URL called a “slug”. Given the example url: theopenskyproject.com/sellername/buy/dogfood/

the slug would be “dogfood”.

The slug or other identifier relates the widget to stored information including the Seller's identity and the product identity and their respective associated meta data. The widget transmits the identifier to the central system and a request for information. In one embodiment the product identifier is unique to both the product and the seller. In that embodiment, a seller identifier does not need to be transmitted to the server because the product identifier is unique to the pairing of seller and the product the seller is promoting. In another embodiment, the products have a unique identifier that is the same across more than one distinct seller. In that case, a seller identifier has to be determined and transmitted to the server so that the server can identify both the product selected and the seller associated with the transaction.

When the customer performs an action with the intention of purchasing a product including pressing a “buy now” or “add to cart” or similar button on the webpage interface, clicking on a hyperlink or dragging an item to a specified location, the product identifier, UUID or slug gets passed to the widget and by the widget to the central server. Server stores the product identifier as part of a shopping cart that is unique to the user. The identifier is mapped to the appropriate price by the server and the price is pulled up in realtime from the server's database. The central system checks the current inventory and then transmits the remaining number of items, in this case, dog collars, back to the originating widget. The widget receives the data and then updates the webpage by writing the appropriate data into the data object that is rendered by the browser as the web page. The customer then instantly sees the inventory available and pricing and other relevant data, including back-order time and that type of information. If another website sells a dog collar, all the web pages with the same product identifier will be updated to reflect the decrease in inventory when they are displayed by a customer's browser. The widget typically causes an overlay window to be displayed over the web-page. This window is not a new browser window but is a visual object that is placed in the foreground.

### Central Servers:

The central server system is comprised of one or more computer servers that are accessible by means of a data network, typically the Internet. This is one or more databases operating on the one or more central servers that service the broadly distributed widgets that are associated with all of the different Sellers' webpages. The widgets on the webpages push data back into the central servers. For example, when the widget sells an item, the widget pushes the product identifying information back into the checkout module that causes the credit card processing module to effectuate the transaction. At the same time, the widget pushes data regarding who the Seller was into the portion of the database that credits Sellers with a portion of the sale revenue derived. Furthermore, the widget pushes sales information into the inventory control portion of the database to cause it to decrement the inventory by the number of items associated with a particular product identifier that were sold by a transaction. The widget accomplishes this interaction with the central servers by relying on a set of interface protocols. Customers may also set up accounts with the central servers. In this embodiment, the widget calls for a customer's login and password. These are transmitted to the checkout module. That information is mapped in the back-end to specific credit card information and customer information so that the transaction can be completed. When checkout is completed, for effectuating delivery fulfillment, the central servers map the unique product identifier or UUID for each product associated with a sale to it's corresponding Supplier and present the Supplier with the fulfillment request data, which includes the quantity and shipping address.

### Transaction Process:

When a sale transaction takes place, the reader of the webpage simply selects the item that they intend to buy. In one embodiment, the widget interacts with the other content comprising the web-page and determines which items are for sale. In this embodiment, each inventory item has a unique identifier associated with it, and the widget “knows” the inventory item identifier by retrieving it from the document data itself. In addition, the Seller is able to integrate the item directly into their web-page so that its appearance and presence is seamless in appearance.

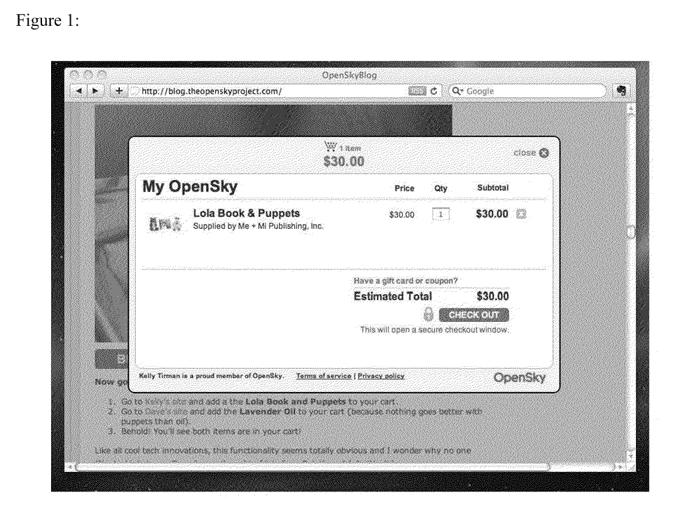

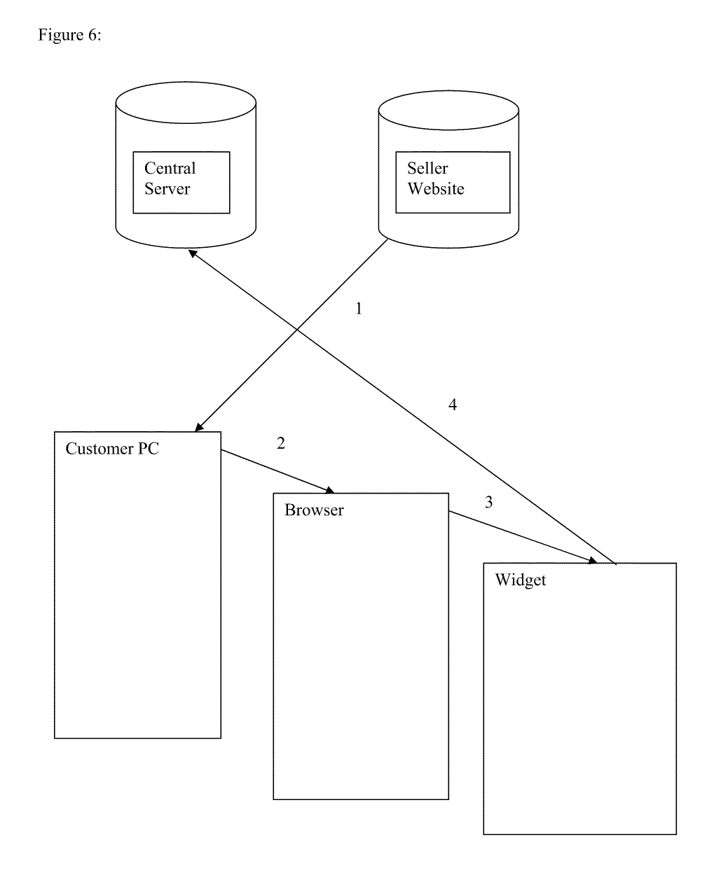

When the customer presses the “buy” button or other action on the Seller's webpage to initiate a transaction, the widget is launched. In another embodiment, the widget code is in-line and therefore is already activated in which case the customer's action will interact with the activated widget. The widget displays an interface for taking some of the customer information, typically the less sensitive information, for example quantity. See FIG. 1. If the user is already registered and authenticated, the user identifier, type of payment and other selections can be input into the widget and saved with shopping cart. In addition, the widget sends a request to the central servers using the customer information to retrieve any saved pending sales of other items the customer has selected but not completed the purchase of. FIG. 6 (4). The central servers receive the request and use the customer identifying information to look up in the database for pending sales associated with the customer identifier, which would include product identifiers, quantity and pricing information.

The widget displays what is referred to as a shopping cart, or a list of selected items, quantity and prices associated with the customer identity. The shopping cart can either be modified, saved or the customer can initiate a checkout, which causes the transaction for the selected items to be completed. In another embodiment, the shopping cart at this point is not associated with a customer, so it only displays the items selected from the webpage.

Each instance of a shopping cart that is launched is associated with the customer. The central system stores a shopping cart for each customer. The pending purchases associated with a customer are stored by the central system. In this embodiment, the central server saves the shopping cart session for a customer and each stored session is linked to a particular customer by means of the customer specific identifier that is present on the user's computer. The customer identity can be determined in several ways. In one embodiment, a login and password is requested. These are sent to the central servers for verification or authentication. In another embodiment, the user's computer may have stored on it data objects, sometimes referred to as “cookies” associated with the distributed architecture system. In this embodiment a secure cookie can be placed on the customer's computer containing an identifier. This information can also be sent back to the central server. The cookie is secured using digital signing and other anti-tampering encryption methodologies. The unique identifier for the customer may also be a stored data value or data derived from specific hardware information on that specific computer.

In another embodiment, the items that a customer has checked out but not purchased may also be stored in a cookie on the customer's computer. The cookie may also contain the present state of the shopping cart. This way, when the widget is activated, the shopping cart that is presented to the user contains pending sale items selected from other participating websites that the user has already visited.

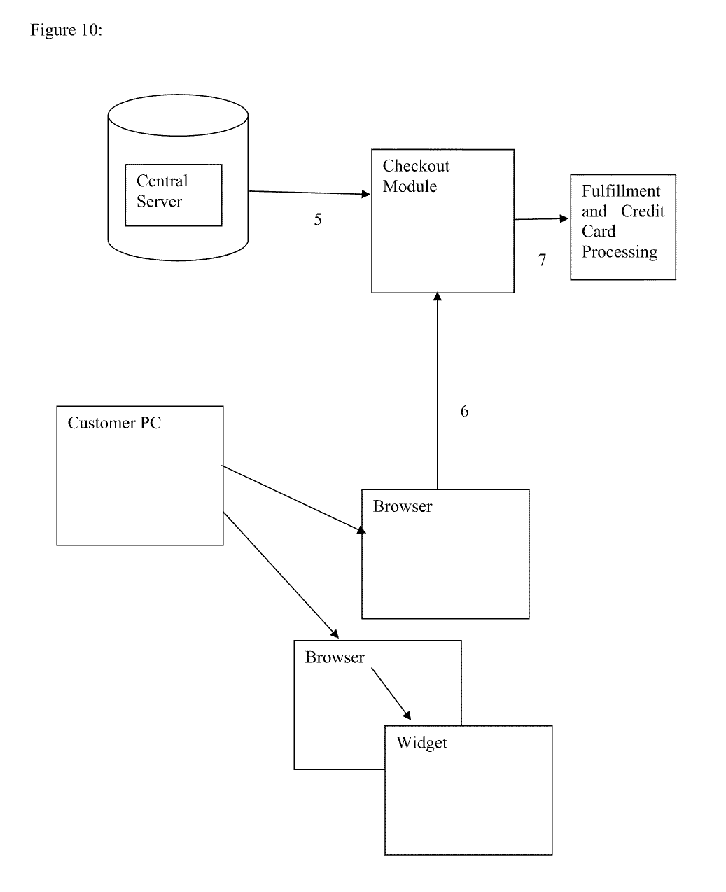

The widget does not conduct the secure credit card transaction. Instead, the widget causes the checkout module to be launched on the central server. That module receives credit card numbers from the customer. The checkout module is actually operating on the central servers and presented as a secure browser window. FIG. 10. The checkout module conducts its interface through a new browser window. Though the transaction is completed in a new window, the checkout module communicates the completion of the transaction to the widget which provides confirmation of the sale and corresponding information. In one embodiment this is accomplished through an iframe in the widget. In another embodiment, the widget modifies the webpage that is displayed. In addition, the checkout module displays the completion of the transaction through an i-frame displayed by the widget. In another embodiment, the widget can poll the server for the data and display it. In another embodiment, the data is pushed to the widget to update the page. This architecture prevents the webpage itself from having code embedded in it that performs secure transactions. In addition, this process and architecture prevents the widget from handling sensitive customer information because the data is captured securely by the central servers through the secure browser window associated with the checkout process executing on the central server. The credit card data received by central server as a result of the checkout process is passed through a secure protocol to the back-end credit card processing module.

An Ajax™ code module causes the customer's computer to display a new window in front of the webpage of the Seller that the customer was looking at. The pop up is highly secure because the customer will input credit card information directly into the system supported by the central system. In another embodiment, an overlay may be used, but this is only secure if the credit card information is already securely stored by the system.

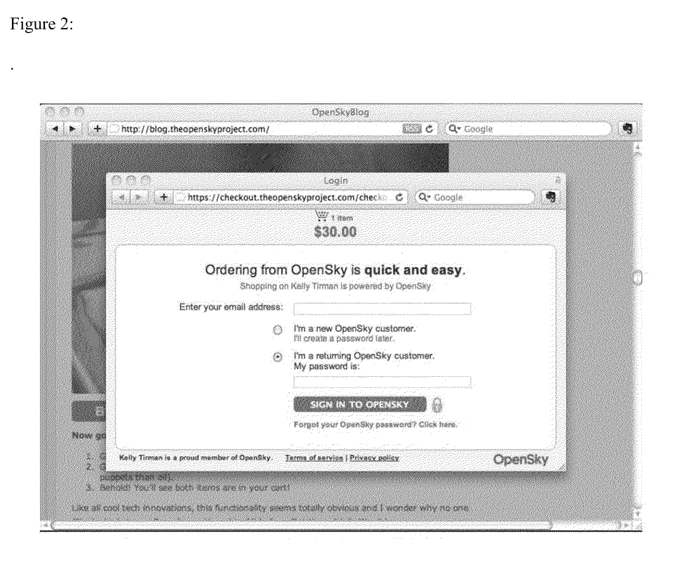

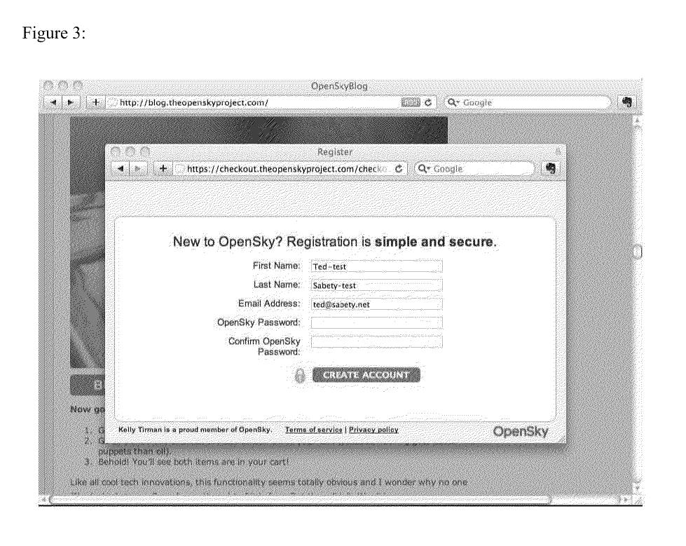

Upon the checkout command, typically initiated by selecting a checkout button on the display, the widget causes a new browser window to open that addresses a website on the central server. FIG. 2, FIG. 10. The central server then requests a login and password or another unique identifier or new customer information, including billing and shipping address and credit card information. FIG. 3, FIG. 10 (6). At this point, the checkout module “knows” which customer is associated with the shopping cart by determining whether the username or other unique customer identifier is associated with any pending shopping cart that was stored on the server earlier with an associated unique identifier. In one embodiment, the customer identifier received by the checkout module is checked for a match against any the customer identifiers that occupy an entry in a data structure that represents a shopping cart. In another embodiment, a token or cookie that has a unique identifying string is used to match the saved shopping cart with the checkout module process running on the central server. The match may be accomplished in several stages: the customer identifier may be mapped to another unique identifier that is matched. Any equivalent way of associating a shopping cart stored at the central server and a specific customer may be used. The stored shopping carts have a unique identifier that can uniquely link the shopping cart to an instance of the checkout procedure operating on the central server. The checkout module can retrieve the shopping cart from the database in order to complete the transaction. FIG. 10 (5). This mechanism is used so that the Seller's website does not contain any code that conducts the credit card transaction itself or other sensitive information: the checkout module, which is hosted on the central server, stands between the Seller's instance of the selling widget and the credit card back-end processing. Shipping information can also be shielded from the seller's website as well by having the checkout module collect that information.

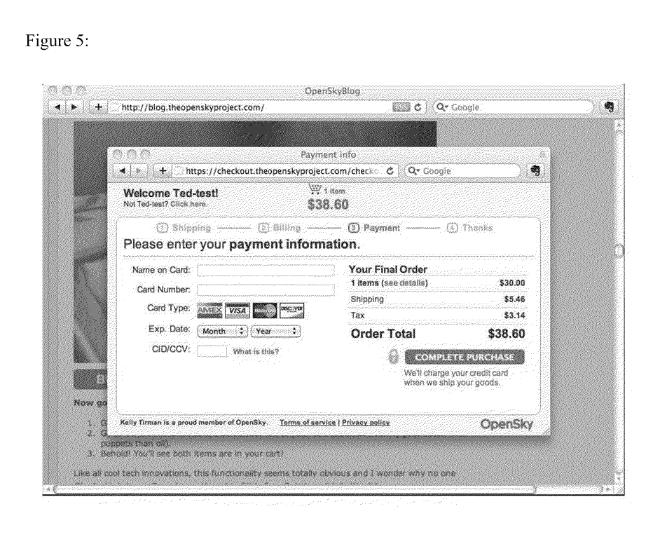

In yet another embodiment, when the customer presses “checkout”, the shopping cart data and the customer identity is transmitted to the central server, where the customer has already established an account. The account is an entry in the central servers where the login, password, credit card information, shipping information and billing information are stored in association with a customer identifier. FIG. 4, FIG. 5. In this instance, the “checkout” simply involves the widget transmitting the shopping cart information with the customer identifier. The server then completes the transaction automatically. In this embodiment, there is no need for the widget to launch a checkout module because the secure information has already been collected by the central server. In yet another embodiment, the program code operating on the user's computer launches a pop-up window. This is a computer process that can perform inter-process communication with the parent window. In this embodiment, the server transmits confirmation data to the displayed web-page in the parent window, or to the pop-up window or to both.

The transaction is completed by the checkout module transmitting the credit card information to a clearing house and retrieving payment confirmation. FIG. 10 (7). In another embodiment, the central server processes the credit card transaction directly. Upon receipt of confirmation, the module then transmits the order information to the system that takes in fulfillment requests, typically the supplier of the selected item. The checkout module finally updates the central servers by decrementing the inventory count for the purchased items, calculating any revenue shares associated with the sales and updating the accounts payable and any other accounting reporting necessary. In one embodiment, the Checkout module reformats and transmits the credit card authorization to a payment clearinghouse. In another embodiment, the checkout module transmits the order data to a fulfillment operator, who actually packages and ships the item. The Checkout module also updates the central servers so that the data associated with the Seller indicates that such a sale has taken place and appropriate credit to the Seller's account be made. Customer information can also be stored in the central servers. In another embodiment, payment may be effectuated by transmitting data other than a credit card number as a payment token. For example, the payment data object that is transmitted can be a Pay Pal™, Google Checkout™ or other on-line payment token representing an amount of money.

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A method of executing a sale transaction initiated by a remote computer operated by a user displaying a web-page associated with a seller comprising:
Receiving a customer identifier from the remote computer;
Retrieving from storage at least one product identifier and associated sales data corresponding to said customer identifier;
Operating an inter-process communication protocol with a secure process operating on the remote computer in order to receive authentication data associated with the user;
Receiving a payment token using the inter-process communication protocol with the secure process operating on the remote computer.

2. The method of claim 1 where the associated sales data is comprised of pricing data.

3. The method of claim 1 where the associated sales data is comprised of quantity data.

4. The method of claim 1 further comprising:
Receiving a login identifier and password; and
Verifying that the login identifier and password are valid.

5. The method of claim 1 where the customer identifier is derived from a cookie transmitted to and stored on said remote computer.

6. The method of claim 1 where the customer identifier is derived from computer hardware comprising the remote computer.

7. The method of claim 1 where the launching step is further comprised of:
Causing an Ajax code module to operate on the remote computer in order that a new browser window opens on the remote computer display.

8. The method of claim 1 where the receiving a payment token step is comprised of retrieving from a database the credit card number associated with the verified login and password data.

9. The method of claim 1 where the retrieving step is comprised of using the received customer identifier to create a database query for at least one product identifier and associated sales data corresponding to the customer identifier and not associated with the seller.

10. The method of claim 9 where the received customer identifier is mapped to another value that is used to query a database to retrieve product identifiers and associated sales data corresponding to the customer identifier.

11. The method of claim 1 further comprising transmitting at least one message containing data representing at least one fulfillment order for the at least one product identifiers.

12. The method of claim 1 or claim 8 further comprising:
Updating at least one database record associated with at least one seller to include a revenue share on the transaction with respect to at least one product identifier that originated from at least one web-page associated with the at least one seller.

13. A computer system comprised of one or more computers operatively connected using one or more data networks that is programmed to execute any of the methods of claims 1-12.

14. A distributed on-line sales system comprising;
A first server that stores data representing pending sales data associated with a plurality of customer identifiers, said pending sales data being comprised of pending sales data associated with transactions initiated from a first seller and an unrelated second seller;
and a second server that executes transaction checkout processing for the pending sales data.

15. The system of claim 14 where the first server and second server are the same computer.

16. The system of claim 14 where the first server and the second server are two different computers under common control.

17. The system of claim 14 where the second server is adapted to request from the first server at least one product identifier and associated sales data, said request comprised of the received customer identifier value.

18. The system of claim 17 where the second server is further adapted to receive from a remote computer a payment token.

19. The system of claim 17 where the second server is further adapted to receive from a remote computer login and password information, to verify the information and to retrieve from a database a credit card number associated with the verified login and password information.

20. The system of claim 17, 18 or 19 where the first server and second server are the same computer.

21. The method of claim 11 where at least two messages are transmitted to two distinct corresponding suppliers.

22. The method of claim 1 where at least two product identifiers are retrieved and each of the at least two product identifiers is associated with at least two distinct sellers.

23. The method of claim 1 further comprising:
Receiving a payment token using the interprocess protocol with the secure process, where the payment token is one of a credit card number, a PayPal token or a Google Checkout token.

24. The method of claim 1 further comprising:
Transmitting to the remote computer transaction confirmation data in order to cause the displayed web-page to be updated or the secure process to display the confirmation data or both.

25. The method of claim 1 further comprising:
Retrieving from storage at least one additional product identifier and associated sales data corresponding to said customer identifier where said additional product identifier is associated with a transaction initiated from a web-page not associated with the seller.

26. A system comprised of one or more computers operatively connected over a data network that together perform the methods of claims 22-25.

27. A computer readable medium containing data that represents computer instructions that when executed, perform any of the methods of claims 1-12 and 22-25.
